(19) United States
(12) Patent Application Publication
(10) Pub. No.: US 2026/0209582 A1
(43) Pub. Date: Jul. 23, 2026

(54) CURABLE SILICONE COMPOSITION

(71) Applicant: DOW SILICONES CORPORATION, Midland, MI (US)

(72) Inventors: Jimok LEE, Chungcheongbuk-Do (KR); Minhee KWON, Chungcheongbuk-Do (KR); Hojin CHOI, Chungcheongbuk-Do (KR)

(21) Appl. No.: 19/143,097

(22) PCT Filed: Dec. 26, 2023
(86) PCT No.: PCT/US2023/085888

§ 371 Date: Jun. 25, 2025

Related U.S. Application Data
(60) Provisional application No. 63/435,631, filed on Dec. 28, 2022.

(51) Int. Cl. C09J 183/04; B32B 7/12; B32B 17/10; C09J 11/04; C09J 11/08

(52) U.S. Cl. CPC C09J 183/04; B32B 7/12; B32B 17/10; C09J 11/04; C09J 11/08; B32B 2457/20; C09J 2203/326; C09J 2400/146; C09J 2483/008

(57) ABSTRACT

This disclosure provides a curable silicone composition having a refractive index at 25° C. of 1.42 to 1.50. The composition comprises: (A) an organopolysiloxane having on average at least one alkenyl group with 2 to 12 carbon atoms and at least one aryl group with 6 to 12 carbon atoms in a molecule; (B) an organohydrogenpolysiloxane having on average at least one silicon-bonded hydrogen atom and at least one aryl group with 6 to 12 carbon atoms in a molecule; (C) a fumed silica; (D) a surfactant selected from a polyether-modified organopolysiloxane and a silicon-free polyether; and (E) a hydrosilylation reaction catalyst. The composition has a good film-forming property on a fluorine film, and cures to form a cured product with transparency and printability. Even if the cured product contacts with a transparent silicone adhesive (“Si-OCA”), it generally prevents migration of components, e.g., MQ resins, from Si-OCA to the cured product.

### CROSS-REFERENCE TO RELATED APPLICATIONS

This application claims priority to and all advantages of U.S. Provisional Patent Application No. 63/435,631 filed on 28 Dec. 2022, the content of which is incorporated herein by reference.

### TECHNICAL FIELD

The present invention relates to a curable silicone composition.

### BACKGROUND ART

Optical displays for foldable phones are generally composed of an ultra-thin glass (UTG), a transparent silicone adhesive (Si-OCA) and a thermoplastic polyurethane (TPU), wherein Si-OCA is used for improving visibility of optical displays. However, TPU has problems such as water absorption and vulnerability to ultraviolet (UV) light. Water-absorbed TPU is mechanically weakened and UV-exposed TPU is discolored to be yellow.

Recently, TPU is considered to be replaced with a silicone-based material. Curable silicone compositions are available for the silicone-based materials. For examples, Patent Document 1 discloses a curable silicone composition for an optical device, comprising: a first siloxane compound having polyether residues, a second siloxane compound having a silicon-bonded hydrogen at a terminal end thereof, a third siloxane compound having a silicon-bonded alkenyl group at a terminal end thereof, and a hydrosilylation reaction catalyst; Patent Document 2 discloses a curable polysiloxane composition comprising: a first siloxane compound having a silicon-bonded alkenyl group at a terminal, a second siloxane compound having a silicon-bonded hydrogen at a terminal, 0.05 to 3% by weight of a hydrophilic polyalkylene oxide compound based on the total weight of the first and second siloxane compounds, and a hydrosilylation reaction catalyst; and Patent Documents 3 and 4 disclose a curable silicone composition comprising: an organopolysiloxane having at least two alkenyl groups in a molecule, an organopolysiloxane having at least two silicon atom-bonded hydrogen atoms in a molecule, a polyether-modified silicone, and a hydrosilylation catalyst.

The silicone-based materials are required to have transparency, printability, and film-forming property on a fluorine film. However, they have problems that their adhesion property tends to decrease due to migration of components such as MQ resins from Si-OCA to the silicone-based materials.

### PRIOR ART DOCUMENTS

### Patent Documents

Patent Document 1: U.S. Patent Application Publication No. 2015/0353688 A1
Patent Document 2: International Patent Application Publication No. WO 2016/006773 A1
Patent Document 3: U.S. Patent Application Publication No. 2020/0385579 A1
Patent Document 4: U.S. Patent Application Publication No. 2020/0385580 A1

### SUMMARY OF INVENTION

### Technical Problem

An object of the present invention is to provide a curable silicone composition which has good film-forming property on a fluorine film, and cures to form a cured product with transparency and printability, and even if the cured product contacts with Si-OCA, it is able to prevent the migration of components such as MQ resins from Si-OCA to the cured product.

### Solution to Problem

The curable silicone composition of the present invention has a refractive index at 25° C. of 1.42 to 1.50 measured by means of an abbe refractometer at a wavelength of 589 nm, wherein the composition comprises:
(A) an organopolysiloxane having on average at least one alkenyl group with 2 to 12 carbon atoms and at least one aryl group with 6 to 12 carbon atoms in a molecule;
(B) an organohydrogenpolysiloxane having on average at least one silicon-bonded hydrogen atom and at least one aryl group with 6 to 12 carbon atoms in a molecule, in an amount such that the silicon-bonded hydrogen atoms in this component are in a range of from 0.1 to 10 moles relative to one mole of the alkenyl groups in component (A);
(C) a silica filler, in a range of from 0.1 to 5 mass % of a total mass of the composition;
(D) a surfactant selected from a polyether-modified organopolysiloxane and a silicon-free polyether, in a range of from 0.01 to 5 mass % of a total mass of the composition; and
(E) a catalytic amount of a hydrosilylation reaction catalyst.

In various embodiments, a content of aryl groups in components (A) and (B) is in a range of from 10 to 40 mass % of a total mass of components (A) and (B).

In various embodiments, component (C) is a fumed or precipitated silica filler with a BET surface area of at least 50 m²/g.

In various embodiments, the polyether-modified organopolysiloxane for component (D) is an organopolysiloxane grafting at least one polyether residue in a molecule.

In various embodiments, the composition further comprises: (F) a hydrosilylation reaction inhibitor, in a range of from 0.01 to 3 mass % of a total mass of the composition.

In various embodiments, the composition further comprises: (G) an organic solvent, in a range of from 0.01 to 3 mass % of a total mass of the composition.

In various embodiments, the composition is a composition for sealing, coating, or adhering an optical element.

The display device of the present invention comprises: an ultra-thin glass (UTG), a transparent silicone adhesive (Si-OCA) and a silicone film, wherein the silicone film is produced by curing the curable silicone composition mentioned above.

### Effects of Invention

The curable silicone composition of the present invention has good film-forming property on a fluorine film, and cures to form a cured product with transparency and printability, and even if the cured product contacts with Si-OCA, it is able to prevent the migration of components such as MQ resins from Si-OCA to the cured product.

### BRIEF DESCRIPTION OF DRAWINGS

FIG. 1 is a photograph of a cured product in Example IE1.

FIG. 2 is a photograph of a cured product in Comparable Example CE1, in which aggregation of a fumed silica was observed.

FIG. 3 is a photograph of a cured product in Comparative Example CE2 or CE7, in which a phenomenon of the Bernard cell was observed.

FIG. 4 is a photograph of a cured product in Comparative Example CE2, in which a shrinkage was observed.

FIG. 5 is a photograph of a cured product in Comparative Example CE4 or CE6, in which a fumed silica was observed because of mismatched refractive index.

FIG. 6 is a photograph of a cured product in Comparative Example CE9, in which a shrinkage was observed.

FIG. 7 is photographs of printability tests in Example IE1 (Right) and Comparative Example CE4 (Left).

### DEFINITIONS

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, 0-5, or ±0-2.5, % of the numerical values. Further, the term “about” applies to both numerical values when associated with a range of values. Moreover, the term “about” may apply to numerical values even when not explicitly stated.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

### DETAILED DESCRIPTION OF THE INVENTION

The curable silicone composition of the present invention will be described in detail.

Component (A) is a base compound of the present composition and is an organopolysiloxane having on average at least one alkenyl group with 2 to 12 carbon atoms and at least one aryl group with 6 to 12 carbon atoms in a molecule. Examples of the alkenyl groups include vinyl groups, allyl groups, butenyl groups, pentenyl groups, hexenyl groups, heptenyl groups, octenyl groups, nonenyl groups, decenyl groups, undecenyl groups, and dodecenyl groups, among which vinyl groups are preferable. Examples of the aryl groups include phenyl groups, tolyl groups, xylyl groups, and naphthyl groups, among which phenyl groups are preferable. In addition, examples of groups bonding to silicon atoms other than the alkenyl groups and aryl groups in component (A) include alkyl groups having from 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups, and dodecyl groups; and groups in which some or all of the hydrogen atoms of the alkyl groups are substituted with halogen atoms such as fluorine atoms, chlorine atoms, or bromine atoms. Furthermore, the silicon atoms in component (A) may have small amounts of hydroxyl groups or alkoxy groups such as methoxy groups or ethoxy groups within a range that does not impair the object of the present invention.

Examples of molecular structures of component (A) include a linear-chain structure, a partially branched linear-chain structure, a branched-chain structure, and a three-dimensional reticular structure. Component (A) may be one type of organopolysiloxane having these molecular structures or may be a mixture of two or more types of organopolysiloxanes having these molecular structures.

A branched organopolysiloxane for component (A) is typically represented by the following average unit formula:

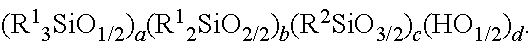

In the formula above, each R¹ is independently an alkyl group with 1 to 12 carbon atoms, alkenyl group with 2 to 12 carbon atoms, or an aryl group with 6 to 12 carbon atoms, and examples thereof include the same groups as described above. However, at least one R¹ in a molecule is an alkenyl group, preferably a vinyl group.

In the formula above, R² is an alkyl group with 1 to 12 carbon atoms or an aryl group with 6 to 12 carbon atoms, and examples thereof include the same groups as described above. However, at least one R² in a molecule is an aryl group, preferably a phenyl group.

In the formula above, “a”, “b”, “c” and “d” are numbers satisfying the following conditions: 0<a≤0.3, 0≤b≤0.2, 0.5≤c≤0.9, 0≤d≤0.05, and a+b+c=1, or optionally 0.1≤a≤0.3, b=0, 0.7≤c≤0.9, 0≤d≤0.05, and a+b+c=1. This is because, if “a”, “b”, “c” and “d” are numbers within the ranges mentioned above, a cured product obtained by curing the present composition will have appropriate hardness and mechanical strength.

A linear organopolysiloxane for component (A) is typically represented by the following general formula:

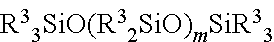

In the formula above, each R³ is independently an alkyl group with 1 to 12 carbon atoms, alkenyl group with 2 to 12 carbon atoms, or an aryl group with 6 to 12 carbon atoms, and examples thereof include the same groups as R¹ described above. However, at least two R³ in a molecule are alkenyl groups and at least one R³ in a molecule is an aryl group, or optionally at least two R³ in a molecule are vinyl groups and at least one R³ in a molecule is a phenyl group.

In the formula above, “m” is an integer of from 10 to 1,000, or optionally an integer of from 10 to 500.

A viscosity at 25° C. of the linear organopolysiloxane is not limited, but is typically not more than 100,000 mPa·s, optionally not more than 50,000 mPa·s, or optionally not more than 20,000 mPa·s. Note that in the present specification, viscosity is the value measured using a type B viscometer according to ASTM D 1084 at 23±2° C.

The linear organopolysiloxanes for component (A) is typically at least one selected from organopolysiloxanes represented by the following formulae:

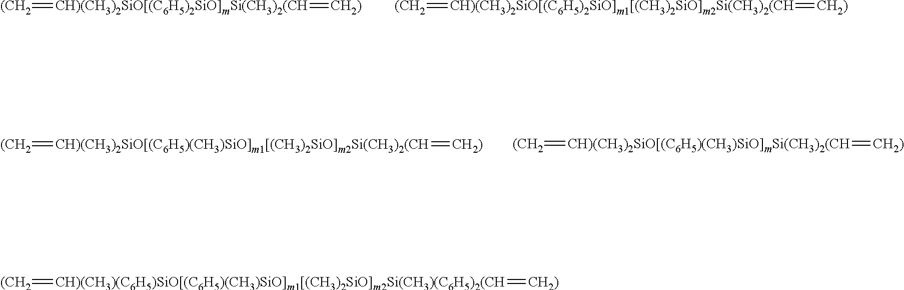

In the formulae above, “m” is as described above, and “m1” and “m2” are integers satisfying: 10≤(m1+m2)≤1,000, or optionally 10≤(m1+m2)≤500.

An amount of component (A) is not limited, but it is typically used in an amount of from 60 to 90 mass %, optionally in an amount of from 65 to 90 mass %, or optionally in an amount of from 70 to 90 mass %, each based on a total mass of components (A) to (C). This is because, if the amount is equal to or above the lower limit of the ranges described above, a cured product obtained by curing the present composition will have appropriate hardness and mechanical strength, whereas the amount is equal to or below the upper limit of the ranges described above, the composition has suitable viscosity at 25° C.

Component (B) is an organosiloxane having on average at least one silicon-bonded hydrogen atoms and at least one aryl group with 6 to 12 carbon atoms in a molecule, and is used as a crosslinking agent for the composition. Examples of the aryl groups include the same groups as described above, among which phenyl groups are preferable. Examples of groups bonding to silicon atoms other than hydrogen atoms and aryl groups include alkyl groups with 1 to 12 carbon atoms such as methyl groups, ethyl groups, propyl groups, isopropyl groups, butyl groups, isobutyl groups, tert-butyl groups, pentyl groups, neopentyl groups, hexyl groups, cyclohexyl groups, heptyl groups, octyl groups, nonyl groups, decyl groups, undecyl groups, and dodecyl groups; and groups in which some or all of the hydrogen atoms of these alkyl groups are substituted with halogen atoms such as fluorine atoms, chlorine atoms, or bromine atoms. Furthermore, the silicon atoms in component (B) may have small amounts of hydroxyl groups or alkoxy groups such as methoxy groups or ethoxy groups within a range that does not impair the object of the present invention.

A viscosity at 25° C. of component (B) is not limited, but is typically not more than 1,000 mPa·s, optionally not more than 500 mPa·s, or optionally not more than 100 mPa·s. Note that in the present specification, viscosity is the value measured using a type B viscometer according to ASTM D 1084 at 23±2° C.

Examples of molecular structures of component (B) include a linear-chain, a partially branched linear-chain, a branched chain, a cyclic, and a three-dimensional reticular structure.

A linear organosiloxane for component (B) is typically represented by the following general formula:

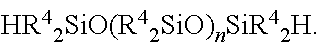

In the formula above, each R⁴ is an alkyl group with 1 to 12 carbon atoms or an aryl group with 6 to 12 carbon atoms, and examples thereof include the same groups as R² described above. However, at least one R⁴ is an aryl group, typically a phenyl group.

In the formula above, “n” is an integer of 0 to 10, optionally an integer of 0 to 5, optionally an integer of 0 to 3, or optionally an integer of 0 or 1.

The linear organosiloxane for component (B) is typically at least one selected from organosiloxane oligomers represented by the following formulae:

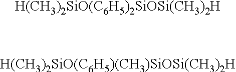

A branched organosiloxane for component (B) is typically represented by the following average unit formula:

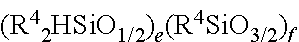

In the formulae above, each R⁴ is an alkyl group or an aryl group, and examples thereof include the same groups as those described above. However, at least one R⁴ is an aryl group, typically a phenyl group.

In the formula above, “e” and “f” are numbers satisfying the following conditions:

$$e > 0 , f > 0 , and e + f = 1 .$$

The branched organosiloxane for component (B) is typically represented by the following average unit formula:

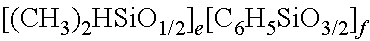

wherein “e” and “f” are as described above.

Component (B) is used in an amount such that silicon-bonded hydrogen atoms in component (B) is in a range from 0.1 to 10 moles, optionally in a range from 0.5 to 1.5 moles, or optionally in a range from 0.8 to 1.5 moles, each relative to one (1) mole of alkenyl groups in component (A). This is because, if the molar ratio is equal to or above the lower limit of the ranges described above, the composition can be fully cured, and a cured product obtained by curing the present composition will have appropriate hardness and mechanical strength, whereas the molar ratio is equal to or below the upper limit of the ranges described above, the cured product has good thermal stability.

Component (C) is a silica filler to improve film-forming property on a fluorine film because it prevents shrinkage during cure of the composition. In addition, strength of the cured product can be improved at the same time. Component (C) is typically fumed or precipitated silica filler with a BET surface area of at least 50 m²/g, optionally 80 to 400 m²/g, or optionally 100 to 400 m²/g. A surface of the silica filer may be un-treated or treated with treating agents such as organochlorosilanes, organoalkoxysilanes, organosilazanes, and organosiloxane oligomers.

The silica filler for component (C) is commercially available. Examples of the silica fillers include fumed silica from Degussa Corporation under the tradename AEROSIL™, such as AEROSIL™ R8200, R9200, R812, R812S, R972, R974, R805, R202; fumed silica from Cabot Corporation under the tradename CAB-O-SIL™ ND-TS, TS610 or TS710; and fumed silica from Tokuyama Corporation under the tradename REOLOSIL™, such as DM-10, DM-20S, DM-30, HM-30S, MT-10, PM-20L, QS-10, QS-20A, and QS-25C.

An amount of component (C) is in a range of from 0.1 to 5 mass %, or optionally in a range of from 0.3 to 2 mass %, of the present composition. This is because, if the amount is equal to or above the lower limit of the ranges described above, the cured product obtained by curing the present composition has appropriate hardness and mechanical strength, whereas the amount is equal to or below the upper limit of the ranges described above, the present composition has good transparency.

Component (D) is a surfactant selected from a polyether-modified organopolysiloxane and a silicon-free polyether, and improves film-forming property of the composition on a fluorine film. In a process of coating and curing the composition, heat convection occurs along with aggregation of polymer chains, resulting in the Bernard cell phenomenon. For this reason, the problem that a surface of the cured product becomes uneven occurs. This phenomenon can be solved by adding component (D), and it helps to obtain a uniform film.

The polyether-modified organopolysiloxane for component (D) is not limited, but is an organopolysiloxane having at least one polyether block or residue in a molecule. That is, the polyether-modified organopolysiloxane is a block copolymer of a polyether block and an organopolysiloxane block, or an organopolysiloxane grafting at least one polyether residue in a molecule. Among them, the organopolysiloxane grafting at least one polyether residue in a molecule is preferable. These polyether-modified organopolysiloxanes are commercially available under the trade names DOWSIL™ 57 Additive, DOWSIL™ 67 Additive, DOWSIL™ 500 W Additive, DOWSIL™ 501 W Additive, and DOWSIL™ 502 W Additive, respectively, from the Dow Chemical Company, Midland, Michigan.

Examples of silicon-free polyethers for component (D) include polyoxyethylene alkyl ethers, polyoxyethylene alkyl phenyl ethers, polyoxyethylene fatty acid esters, sorbitan fatty acid esters, and polyoxyethylene sorbitan fatty acid esters. The silicon-free polyethers are commercially available. Examples of the silicon-free polyether include 2,6,8-trimethyl-4-nonyl polyoxyethylene ether under the trade names TERGITOL™ TMN-6 and TERGITOL™ TMN-10; C₁₁₋₁₅ secondary alkyl polyoxyethylene ethers under the trade names TERGITOL™ 15-S-3, TERGITOL™ 15-S-7, TERGITOL™ 15-S-9, TERGITOL™ 15-S-15, TERGITOL™ 15-S-30, and TERGITOL™ 15-S-40, by the Dow Chemical Company, Midland, Michigan.

An amount of component (D) is in a range of from 0.01 to 5 mass %, or optionally in a range of from 0.1 to 2 mass % of the composition. This is because when the content of component (D) is greater than or equal to the lower limit of the aforementioned range, This is because, if the amount is equal to or above the lower limit of the ranges described above, the cured product obtained by curing the present composition has appropriate hardness and mechanical strength, whereas the amount is equal to or below the upper limit of the ranges described above, the present composition has good transparency.

Component (E) is a hydrosilylation reaction catalyst used to accelerate the curing of the present composition. Examples of component (E) include platinum group element catalysts and platinum group element compound catalysts, and specific examples include platinum-based catalysts, rhodium-based catalysts, palladium-based catalysts, and combinations of at least two types thereof. In particular, platinum-based catalysts are preferable in that the curing of the present composition can be dramatically accelerated. Examples of component (E) include finely powdered platinum; platinum black; chloroplatinic acid, alcohol-modified chloroplatinic acid; chloroplatinic acid/diolefin complexes; platinum/olefin complexes; platinum/carbonyl complexes such as platinum bis(acetoacetate), and platinum bis(acetylacetonate); chloroplatinic acid/alkenylsiloxane complexes such as chloroplatinic acid/divinyltetramethyl disiloxane complexes, and chloroplatinic acid/tetravinyl tetramethyl cyclotetrasiloxane complexes; platinum/alkenylsiloxane complexes such as platinum/divinyltetramethyl disiloxane complexes, and platinum/tetravinyl tetramethyl cyclotetrasiloxane complexes; complexes of chloroplatinic acid and acetylene alcohols; and mixtures of two or more types thereof. In particular, platinum-alkenylsiloxane complexes are preferable in that they yield an excellent accelerating effect.

Examples of the alkenylsiloxane used in the platinum-alkenylsiloxane complex include 1,3-divinyl-1,1,3,3-tetramethyldisiloxane, 1,3,5,7-tetramethyl-1,3,5,7-tetravinylcyclotetrasiloxane, alkenylsiloxane oligomers in which some of the methyl groups of these alkenylsiloxanes are substituted with ethyl groups, phenyl groups, or the like, and alkenylsiloxane oligomers in which the vinyl groups of these alkenylsiloxanes are substituted with allyl groups, hexenyl groups, or the like. In particular, 1,3-divinyl-1,1,3,3-tetramethyldisiloxane is preferable in that the stability of the platinum-alkenylsiloxane complex that is produced is good.

In order to improve the stability of the platinum-alkenylsiloxane complexes, it is preferable to dissolve these platinum-alkenylsiloxane complexes in an alkenylsiloxane oligomer such as 1,3-divinyl-1,1,3,3-tetramethyldisiloxane, 1,3-diallyl-1,1,3,3-tetramethyldisiloxane, 1,3-divinyl-1,3-dimethyl-1,3-diphenyldisiloxane, 1,3-divinyl-1,1,3,3-tetraphenyldisiloxane, or 1,3,5,7-tetramethyl-1,3,5,7-tetravinylcyclotetrasiloxane or an organosiloxane oligomer such as a dimethylsiloxane oligomer, and it is particularly preferable to dissolve the complexes in an alkenylsiloxane oligomer.

An amount of component (E) is not limited, but is typically in an amount such that the content of platinum atoms in component (E) is in the range of from 0.01 to 500 ppm, optionally in the range of from 0.01 to 100 ppm, or optionally in the range of from 0.1 to 50 ppm in terms of mass units with respect to the present composition. This is because when the amount is greater than or equal to the lower limit of the aforementioned range, the curability of the obtained composition is good, whereas when the amount is less than or equal to the upper limit of the aforementioned range, the coloration of the obtained cured product is suppressed.

The present composition may contain (F) a hydrosilylation reaction inhibitor in order to prolong the usable time at ambient temperature and to improve storage stability. Examples of component (F) include alkyne alcohols such as 1-ethynylcyclohexan-1-ol, 2-methyl-3-butyn-2-ol, 3,5-dimethyl-1-hexyn-3-ol, and 2-phenyl-3-butyn-2-ol; ene-yne compounds such as 3-methyl-3-penten-1-yne, 3-methyl-3-hexen-1-yne, 1-ethynyl cyclohexene, 3-ethyl-3-buten-1-yne, 3-phenyl-3-buten-1-yne, and 3,5-dimethyl-3-hexen-1-yne; unsaturated carboxylic esters such as diallyl maleate, dimethyl maleate, diethyl fumarate, diallyl fumarate, and bis(2-methoxy-1-methylethyl) maleate, mono-octylmaleate, mono-isooctylmaleate, mono-allyl maleate, mono-methyl maleate, mono-ethyl fumarate, mono-allyl fumarate, and 2-methoxy-1-methylethylmaleate; alkynoxysilanes such as dimethyl bis(3-methyl-1-butyn-3-oxy)silane and methylvinyl bis(3-methyl-1-butyn-3-oxy)silane; triallylisocyanurate compounds; and mixtures of two or more types thereof. In particular, a mixture of an alkyne alcohol and an unsaturated carboxylic ester is preferable in order to prevent the cured product from developing surface wrinkle.

An amount of component (F) is not limited, but is typically in the range of from 0.0001 to 5 mass %, or optionally in the range of from 0.005 to 3 mass % of the composition.

In addition, the present composition may contain (G) a solvent in order to reduce the viscosity thereof and to improve the application workability or wettability. Examples of component (G) include: hydrocarbon-based solvents such as aromatic hydrocarbon-based solvents such as toluene and xylene, aliphatic hydrocarbon-based solvents such as hexane, heptane, octane, isooctane, decane, cyclohexane, methylcyclohexane, and isoparaffin, industrial gasoline (rubber solvents or the like), petroleum benzene, and solvent naphtha; ketone-based solvents such as acetone, methyl ethyl ketone, 2-pentanone, 3-pentanone, 2-hexanone, 2-heptanone, 4-heptanone, methyl isobutyl ketone, diisobutyl ketone, acetonyl acetone, and cyclohexanone; ester-based solvents such as ethyl acetate, propyl acetate, isopropyl acetate, butyl acetate, and isobutyl acetate; ether-based solvents such as diethyl ether, dipropyl ether, diisopropyl ether, dibutyl ether, 1,2-dimethoxyethane, and 1,4-dioxane; solvents having ester and ether components such as 2-methoxyethylacetate, 2-ethoxyethylacetate, propylene glycol monoether acetate, and 2-butoxyethylacetate; siloxane-based solvents such as hexamethyl disiloxane, octamethyl trisiloxane, octamethyl cyclotetrasiloxane, decamethyl cyclopentasiloxane, tris(trimethylsiloxy)methylsilane, and tetrakis(trimethylsiloxy)silane; fluorine-based solvents such as trifluorotoluene, hexafluoroxylene, methyl nonafluorobutyl ether, and ethyl nonafluorobutyl ether; and mixed solvents of two or more types thereof.

An amount of component (G) is not limited, but it is typically in an amount ranging from about 1 to 10 mass % of the composition.

In order to improve adhesion of the cured product to a base material being contacted during curing, the present composition may contain an adhesion promotor. In certain embodiments, the adhesion promotor is typically an organosilicon compound having at least one alkoxy group bonded to a silicon atom in a molecule. This alkoxy group is exemplified by a methoxy group, an ethoxy group, a propoxy group, a butoxy group, and a methoxyethoxy group; and the methoxy group is most typical. Moreover, non-alkoxy groups bonded to a silicon atom of this organosilicon compound are exemplified by substituted or non-substituted monovalent hydrocarbon groups such as alkyl groups, alkenyl groups, aryl groups, aralkyl groups, halogenated alkyl groups and the like; epoxy group-containing monovalent organic groups such as a 3-glycidoxypropyl group, a 4-glycidoxybutyl group, or similar glycidoxyalkyl groups; a 2-(3,4-epoxycyclohexyl)ethyl group, a 3-(3,4-epoxycyclohexyl)propyl group, or similar epoxycyclohexylalkyl groups; and a 4-oxiranylbutyl group, an 8-oxiranyloctyl group, or similar oxiranylalkyl groups; acrylic group-containing monovalent organic groups such as a 3-methacryloxypropyl group and the like; and a hydrogen atom. This organosilicon compound generally has a silicon-bonded alkenyl group or silicon-bonded hydrogen atom. Moreover, due to the ability to impart good adhesion with respect to various types of base materials, this organosilicon compound generally has at least one epoxy group-containing monovalent organic group in a molecule. This type of organosilicon compound is exemplified by organosilane compounds, organosiloxane oligomers and alkyl silicates. Molecular structure of the organosiloxane oligomer or alkyl silicate is exemplified by a linear chain structure, partially branched linear chain structure, branched chain structure, ring-shaped structure, and net-shaped structure. A linear chain structure, branched chain structure, and net-shaped structure are typical. This type of organosilicon compound is exemplified by silane compounds such as 3-glycidoxypropyltrimethoxysilane, 2-(3,4-epoxycyclohexyl)ethyltrimethoxysilane, 3-methacryloxy propyltrimethoxysilane, and the like; siloxane compounds having at least one silicon-bonded alkenyl group or silicon-bonded hydrogen atom, and at least one silicon-bonded alkoxy group in a molecule; mixtures of a silane compound or siloxane compound having at least one silicon-bonded alkoxy group and a siloxane compound having at least one silicon-bonded hydroxyl group and at least one silicon-bonded alkenyl group in the molecule; and methyl polysilicate, ethyl polysilicate, and epoxy group-containing ethyl polysilicate.

An amount of the adhesion promotor is not particularly limited, but in order to achieve good adhesion to a base material being contacted during curing, it is typically at most 10 mass % of the composition.

A refractive index (RI) at 25° C. measured by means of an abbe refractometer at a wavelength of 589 nm of the present composition is in a range from 1.42 to 1.50, optionally in a range from 1.44 to 1.50, or optionally in a range from 1.44 to 1.48. This is because, if the RI of the present composition is below the lower limit of the ranges described above, the composition can coat well on fluorine film without any problem; however, the cured product obtained by curing the composition has poor printability and there is migration of MQ resins from Si-OCA and thus its adhesion tends to decrease. Whereas, if the RI is over the upper limit of the ranges described above, the composition can solve the problems of printability, and prevents a decrease in the adhesion with Si-OCA; however, the composition has a poor film-forming property, and shrinkage can occur. These problems can be solved by adding component (C), however there is a mismach between component (C) and the composition. Without being bound or limited to any particular theory, to solve such problems, it is believed that a key point is that the present composition has a RI mentioned above. To control the RI of the composition, a content of total aryl groups in components (A) and (B) is typically in a range from 10 to 40 mass %, or optionally in a range from 15 to 30 mass %, of a total mass of components (A) and (B).

The present composition is such that curing proceeds either when left to stand at room temperature or when heated, but it is preferable to heat the composition in order to achieve rapid curing. The heating temperature is preferably in the range of from 50 to 200° C.

The present composition preferably forms a cured product with a Shore A hardness of from 15 to 99, or optionally of from 30 to 95, measured by means of a Shore A Durometer when cured. This is because when the hardness of the cured product of the curable silicone composition is greater than or equal to the lower limit of the aforementioned range, it is strong and demonstrates sufficient protection, whereas when the hardness is less than or equal to the upper limit of the aforementioned range, the cured product becomes flexible and the durability is sufficient.

The present composition is preferably a curable silicone composition for sealing, coating, or adhering an optical semiconductor element.

### EXAMPLES

The curable silicone composition of the present invention will be described in detail hereinafter using Practical Examples and Comparative Examples. However, the present invention is not limited by the description of the below listed Examples.

### [Refractive Index]

A refractive index at 25° C. of the curable silicone composition was measured by means of an abbe refractometer produced by ATAGO Co., Ltd. at a wavelength of 589 nm under atmospheric pressure of 1013 mbar in accordance with the standard DIN 51423.

### [Viscosity]

Viscosities at 25±2° C. of the curable silicone compositions were measured by means of a Brookfield cone and plate viscometer (model HB DV Ill ULTRA) with the cone spindle CPA-52Z according to ASTM D 1084.

### [Film-forming Property]

The curable silicone composition is coated on a fluorine-coated PET film by a bar coater in a manner that a thickness of the composition is 300 μm. Then, the composition is cured at 150° C. for 2 minutes. Film-forming property of the cured product is observed.

### [Shore A Hardness]

Pour the curable silicone composition into an aluminum dish to a thickness of 1 cm, and cure it in an oven at 150° C. for 30 minutes. The cured product is measured with a Shore A Durometer.

### [Printability]

Prepare the cured film(sheet). Draw a line on the surface of the cured film using the permanent marker pen.

### [MQ Migration Issue]

Pour the liquid PSA on the cured film, and curing the PSA at 150° C., 2 minutes at the film dryer. 30 minutes after the PSA is cured, a 180° peel test with glass is performed to check the adhesion. Adhesion is also checked under 85° C./85% RH conditions in the same way. When the adhesions are different, MQ migration issue seems to be observed.

### Examples IE1-IE9 and Comparative Examples CE1-CE9

The following components were uniformly mixed according to the compositions (parts by mass) shown in the following Tables 1-3 to prepare the curable silicone compositions of Examples IE1-IE9 and Comparative Examples CE1-CE9. Moreover, in Tables 1-3, “SiH/Vi” represents the total moles of silicon-bonded hydrogen atoms in component (B) relative to 1 mole of total vinyl groups in component (A) in the curable silicone composition. The results of measurements of the curable silicone composition and the cured products are shown in Tables 1-3. The compositions were prepared as follows.

Curable silicone compositions were prepared by blending together components (A), (B), (C), (D), (F) and (G) in a 200 mL polyethylene cup. The mixture was mixed at 2000 rpm for 2 minutes. Finally, component (E) was added; and the composition were mixed at 2000 rpm for 2 minutes.

The following components were used as component (A).
(a1): a branched organopolysiloxane represented by the following average unit formula:

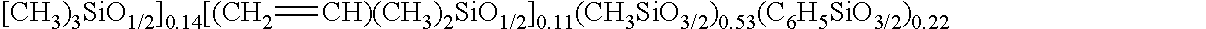

having a viny group content of about 3.47 mass % an a phenyl group content of about 19.8 mass %.
(a2): a methylphenylpolysiloxane represented by the following formula:

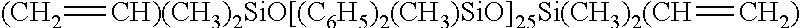

and having a vinyl group content of about 1.51 mass % and a phenyl group content of about 53.7 mass %.
(a3): a copolymer of dimethylsiloxane and diphenylsiloxane represented by the following formula:

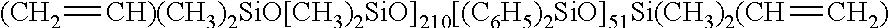

and having a vinyl group content of about 0.21 mass % and a phenyl group content of about 30.4 mass %.
(a4): a dimethylpolysiloxane represented by the following formula:

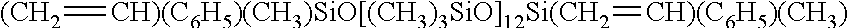

and having a vinyl group content of about 4.08 mass % and a phenyl group content of about 23.3 mass %.
(a5): a dimethylpolysiloxane represented by the following formula:

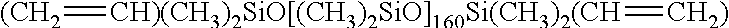

and having a vinyl content of about 0.45 mass %.

The following components were used as component (B).
(b1): a trisiloxane represented by the following formula:

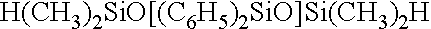

and having a silicon-bonded hydrogen atom content of about 0.61 mass % and a phenyl group content of about 46.4 mass %.
(b2): a branched organopolysiloxane represented by the following average unit formula:

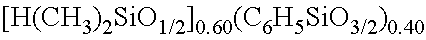

having a silicon-bonded hydrogen atom content of about 0.66 mass % and a phenyl group content of about 33.5 mass %.
(b3): a copolymer of dimethylsiloxane and methylhydrogensiloxane represented by the following average formula:

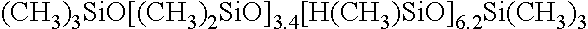

and having a silicon-bonded hydrogen atom content of about 0.79 mass %.

The following components was used as component (C).
(c1): a fumed silica with a BET specific surface area of 230 m²/g (REOLOSIL DM-30S from TOKUYAMA Corporation)

The following components were used as component (D).
(d1): a polyether-modified organopolysiloxane (DOWSIL™ 57 Additive from the Dow Chemical Company)
(d2): a C₁₁₋₁₅ secondary alkyl polyoxyethylene ether (TERGITOL™ 15-S-9 Surfactant from the Dow Chemical Company)
(d3): a C₁₁₋₁₅ secondary alkyl polyoxyethylene ether (TERGITOL™ 15-S-3 Surfactant from the Dow Chemical Company)
(d4): perfluorooctane

The following component was used as component (E).
(e1): 11 mass % —a platinum 1,3-divinyl-1,1,3,3-tetramethyldisiloxane complex of a 1,3-divinyl-1,1,3,3-tetramethyldisiloxane and isopropanol solution

The following component were used as component (F).
(f1): bis(methoxymethyl)ethyl maleate
(f2): methyl-tris(1,1-dimethyl-2-propynyloxy) silane

The following component was used as component (G).
(g1): toluene

TABLE 1
Category

| | | | Examples | | | Comparative Examples | | |
|---|---|---|---|---|---|---|---|---|
| Item | | | IE1 | IE2 | IE3 | CE1 | CE2 | CE3 |
| Curable | (A) | (a1) | 72.86 | 72.86 | 72.86 | 73.67 | 74.15 | 72.86 |
| Silicone | | (a2) | — | — | — | — | — | — |
| Composition | | (a3) | 1.00 | 1.00 | 1.00 | 1.00 | 1.00 | 1.00 |
| (parts | | (a4) | — | — | — | — | — | — |
| by | | (a5) | — | — | I | — | — | — |
| mass) | (B) | (b1) | 11.55 | 11.55 | 11.55 | 11.68 | 11.76 | 11.55 |
| | | (b2) | 3.80 | 3.80 | 3.80 | 3.80 | 3.80 | 3.80 |
| | | (b3) | — | — | — | — | — | — |
| | (C) | (c1) | 1.50 | 1.50 | 1.50 | 1.50 | — | 1.50 |
| | (D) | (d1) | 0.94 | — | — | — | 0.94 | — |
| | | (d2) | — | 0.94 | — | — | — | — |
| | | (d3) | — | — | 0.94 | — | — | — |
| | | (d4) | — | — | — | — | — | 0.94 |
| | (E) | (e1) | 0.01 | 0.01 | 0.01 | 0.01 | 0.01 | 0.01 |
| | (F) | (f1) | 0.10 | 0.10 | 0.10 | 0.10 | 0.10 | 0.10 |
| | | (f2) | 0.001 | 0.001 | 0.001 | 0.001 | 0.001 | 0.001 |
| | (G) | (g1) | 8.00 | 8.00 | 8.00 | 8.00 | 8.00 | 8.00 |

| SIH/Vi | | 1.0 | 1.0 | 1.0 | 1.0 | 1.0 | 1.0 |
|---|---|---|---|---|---|---|---|
| Ph content (mass %) | | 23.9 | 23.9 | 23.9 | 23.9 | 23.9 | 23.9 |
| Refractive Index | | 1.478 | 1.478 | 1.478 | 1.478 | 1.478 | 1.478 |
| Viscosity (mPa · s) | | 590 | 3040 | 3618 | 580 | 550 | 2996 |
| Film-forming Property | | ○ | ○ | ○ | ○ | ○ | ○ |
| Transparency | | ○ | ○ | ○ | ○ | ○ | x |
| Cured | Shore A Hardness | 74 | 80 | 77 | 73 | 68 | 75 |
| Product | Optical Property | Good | Good | Good | Good | Good | Bad |
| | Appearance | Good | Good | Good | Bad | Bad | Bad |
| | Shrinkage Issue | None | None | None | None | Observed | None |
| | Printability | ○ | ○ | ○ | ○ | ○ | ○ |
| | Migration Issue | None | None | None | None | None | None |

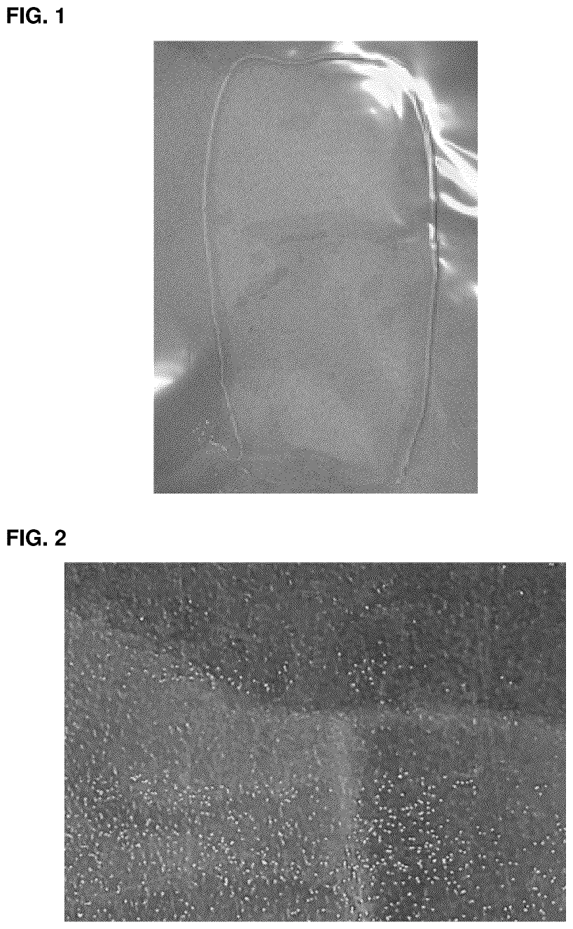

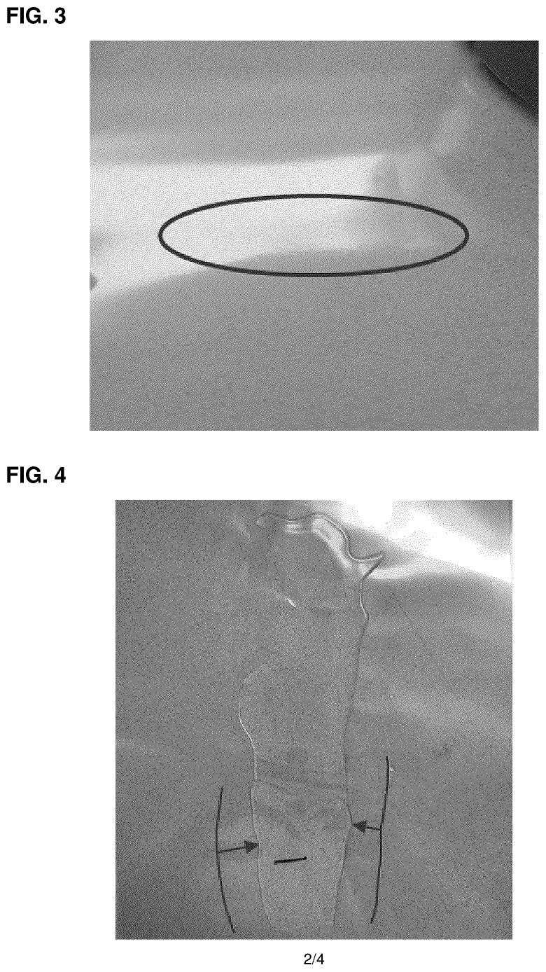

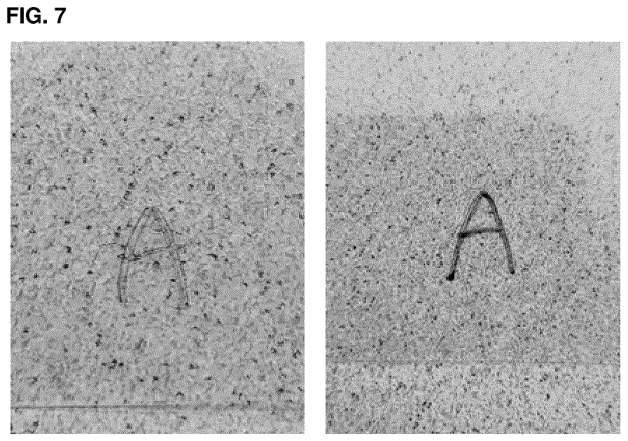

According to a photograph (FIG. 1) of Example IE1, it was confirmed that the curable silicone composition had good film-forming property and the cured product had no shrinkage issue. According to a photograph (FIG. 2) of Comparative Example CE1, it was confirmed that appearance of the cured product was bad because aggregation of a fumed silica was observed. According to a photograph (FIG. 3) of Comparative Example CE2, it was confirmed that appearance of the cured product was bad because a phenomenon of the Bernard cell, which was specified by a circle, was observed. According to a photograph (FIG. 4) of Comparative Example CE2, it was confirmed that a shrinkage of the cured product, which was specified by lines, was observed. According to a right photograph (FIG. 7) of Example IE1, it was confirmed that the cured product had good printability.

TABLE 2
Category

| | | | Examples | | | | | |
|---|---|---|---|---|---|---|---|---|
| Item | | | IE4 | IE5 | IE6 | IE7 | IE8 | IE9 |
| Curable | (A) | (a1) | 73.89 | 73.41 | 72.81 | 72.43 | — | — |
| Silicone | | (a2) | — | — | — | — | — | — |
| Composition | | (a3) | 1.00 | 1.00 | 1.00 | 1.00 | 88.31 | — |
| (parts | | (a4) | — | — | — | — | — | 72.45 |
| by | | (a5) | — | — | — | — | — | — |
| mass) | (B) | (b1) | 11.72 | 11.64 | 11.55 | 11.49 | — | — |
| | | (b2) | 3.80 | 3.80 | 3.80 | 3.80 | 1.14 | 17.00 |
| | | (b3) | — | — | — | — | — | — |
| | (C) | (c1) | 0.30 | 1.50 | 1.50 | 2.00 | 1.50 | 1.50 |
| | (D) | (d1) | 0.94 | 0.30 | 1.00 | 0.94 | 0.94 | 0.94 |
| | | (d2) | — | — | — | — | — | — |
| | | (d3) | — | — | — | — | — | — |
| | | (d4) | — | — | — | — | — | — |
| | (E) | (e1) | 0.01 | 0.01 | 0.01 | 0.01 | 0.01 | 0.01 |
| | (F) | (f1) | 0.10 | 0.10 | 0.10 | 0.10 | 0.10 | 0.10 |
| | | (f2) | 0.001 | 0.001 | 0.001 | 0.001 | — | — |
| | (G) | (g1) | 8.00 | 8.00 | 8.00 | 8.00 | 8.00 | 8.00 |

| SIH/Vi | | 1.0 | 1.0 | 1.0 | 1.0 | 1.1 | 1.0 |
|---|---|---|---|---|---|---|---|
| Ph content (mass %) | | 23.9 | 23.9 | 23.9 | 24.0 | 30.4 | 25.2 |
| Refractive Index | | 1.478 | 1.478 | 1.478 | 1.478 | 1.484 | 1.460 |
| Viscosity (mPa · s) | | 600 | 600 | 583 | 696 | 780 | 570 |
| Film-forming Property | | ○ | ○ | ○ | ○ | ○ | ○ |
| Transparency | | ○ | ○ | ○ | ○ | ○ | ○ |
| Cured | Shore A Hardness | 70 | 74 | 74 | 78 | 75 | 73 |
| Product | Optical Property | Good | Good | Good | Good | Good | Good |
| | Appearance | Good | Good | Good | Good | Good | Good |
| | Shrinkage Issue | None | None | None | None | None | None |
| | Printability | ○ | ○ | ○ | ○ | ○ | ○ |
| | Migration Issue | None | None | None | None | None | None |

TABLE 3
Category

| | | | Comparative Examples | | | | | |
|---|---|---|---|---|---|---|---|---|
| Item | | | CE4 | CE5 | CE6 | CE7 | CE8 | CE9 |
| Curable | (A) | (a1) | — | — | — | — | — | — |
| Silicone | | (a2) | — | — | — | 80.85 | 81.79 | 82.35 |
| Composition | | (a3) | — | — | — | — | — | — |
| (parts | | (a4) | — | — | — | — | — | — |
| by | | (a5) | 87.57 | 88.49 | 89.05 | — | — | — |
| mass) | (B) | (b1) | — | — | — | | — | — |
| | | (b2) | — | — | — | 8.60 | 8.60 | 8.60 |
| | | (b3) | 1.88 | 1.90 | 1.90 | — | — | — |
| | (C) | (c1) | 1.50 | 1.50 | — | 1.50 | 1.50 | — |
| | (D) | (d1) | 0.94 | — | 0.94 | 0.94 | — | 0.94 |
| | | (d2) | — | — | — | — | — | — |
| | | (d3) | — | — | — | — | — | — |
| | | (d4) | — | — | — | — | — | — |
| | (E) | (e1) | 0.01 | 0.01 | 0.01 | 0.01 | 0.01 | 0.01 |
| | (F) | (f1) | 0.10 | 0.10 | 0.10 | 0.10 | 0.10 | 0.10 |
| | | (f2) | — | — | — | — | — | — |
| | (G) | (g1) | 8.00 | 8.00 | 8.00 | 8.00 | 8.00 | 8.00 |

| SIH/Vi | | 0.7 | 0.7 | 0.7 | 0.7 | 0.7 | 0.7 |
|---|---|---|---|---|---|---|---|
| Ph content (mass %) | | 0 | 0 | 0 | 51.8 | 51.8 | 51.8 |
| Refractive Index | | 1.400 | 1.400 | 1.400 | 1.520 | 1.520 | 1.520 |
| Viscosity (mPa · s) | | 410 | 430 | 380 | 4020 | 4080 | 3580 |
| Film-forming Property | | ○ | ○ | ○ | ○ | ○ | x |
| Transparency | | x | x | ○ | x | x | ○ |
| Cured | Shore A Hardness | 50 | 51 | 44 | 90 | 96 | 90 |
| Product | Optical Property | Bad | Bad | Good | Bad | Bad | Bad |
| | Appearance | Good | Good | Good | Bad | Bad | Bad |
| | Shrinkage Issue | None | None | None | None | None | Observed |
| | Printability | x | x | x | ○ | ○ | ○ |
| | Migration Issue | Observed | Observed | Observed | None | None | None |

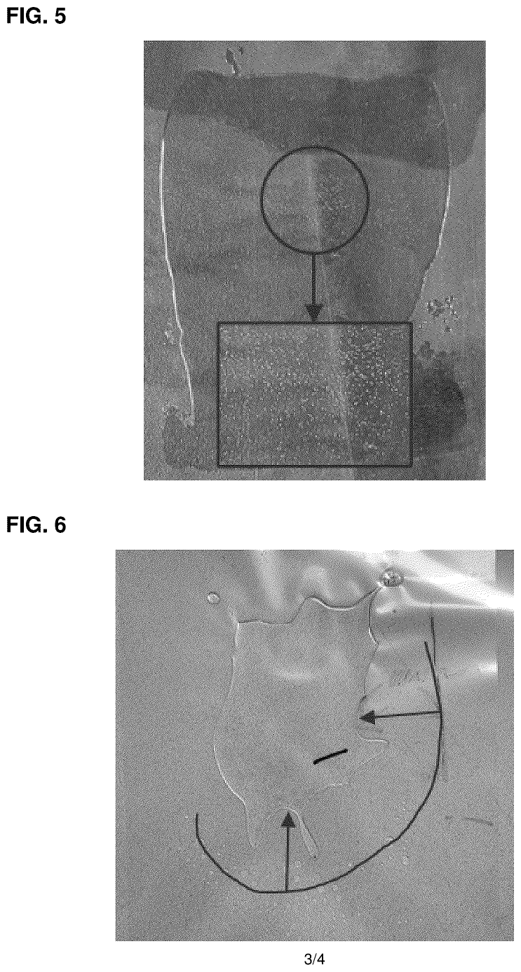

According to a photograph (FIG. 5) of Comparative Example CE4, it was confirmed that the fumed silica in the cured product, which was specified by a circle and a square, was observed because of mismatched refractive index. According to a photograph (FIG. 6) of Comparative Example CE9, it was confirmed that a shrinkage of the cured product, which was specified by lines, was observed. According to a left photograph (FIG. 7) of Comparative Example CE4, it was confirmed that the cured product had bad printability.

### INDUSTRIAL APPLICABILITY

The curable silicone composition of the present invention has good film-forming property on a fluorine film, and cures to form a cured product with transparency and printability, and it is therefore suitable as a sealing agent, a coating agent, or an adhesive for an optical display.

1. A curable silicone composition having a refractive index at 25° C. of 1.42 to 1.50 measured by means of an abbe refractometer at a wavelength of 589 nm, the composition comprising:
(A) an organopolysiloxane having on average at least one alkenyl group with 2 to 12 carbon atoms and at least one aryl group with 6 to 12 carbon atoms in a molecule;
(B) an organohydrogenpolysiloxane having on average at least one silicon-bonded hydrogen atom and at least one aryl group with 6 to 12 carbon atoms in a molecule, in an amount such that the silicon-bonded hydrogen atoms in this component are in a range of from 0.1 to 10 moles relative to one mole of the alkenyl groups in component (A);
(C) a silica filler, in a range of from 0.1 to 5 mass % of a total mass of the composition;
(D) a surfactant selected from a polyether-modified organopolysiloxane and a silicon-free polyether, in a range of from 0.01 to 5 mass % of a total mass of the composition; and
(E) a catalytic amount of a hydrosilylation reaction catalyst.

2. The curable silicone composition according to claim 1, wherein a content of aryl groups in components (A) and (B) is in a range of from 10 to 40 mass % of a total mass of components (A) and (B).

3. The curable silicone composition according to claim 1, wherein component (C) is a fumed or precipitated silica filler with a BET surface area of at least 50 m²/g.

4. The curable silicone composition according to claim 1, wherein the polyether-modified organopolysiloxane for component (D) is an organopolysiloxane grafting at least one polyether residue in a molecule.

5. The curable silicone composition according to claim 1, further comprising:
(F) a hydrosilylation reaction inhibitor, in a range of from 0.01 to 3 mass % of a total mass of the composition.

6. The curable silicone composition according to claim 1, further comprising:
(G) an organic solvent, in a range of from 0.01 to 3 mass % of a total mass of the composition.

7. The curable silicone composition according to claim 1, which is a composition for sealing, coating, or adhering an optical element.

8. A display device comprising: an ultra-thin glass (UTG), a transparent silicone adhesive (Si-OCA) and a silicone film, wherein the silicone film is produced by curing the curable silicone composition according to claim 1.

9. The curable silicone composition according to claim 4, further comprising:
(F) a hydrosilylation reaction inhibitor, in a range of from 0.01 to 3 mass % of a total mass of the composition.

10. The curable silicone composition according to claim 9, further comprising:
(G) an organic solvent, in a range of from 0.01 to 3 mass % of a total mass of the composition.

11. The curable silicone composition according to claim 4, further comprising:
(G) an organic solvent, in a range of from 0.01 to 3 mass % of a total mass of the composition.

12. The curable silicone composition according to claim 5, further comprising:
(G) an organic solvent, in a range of from 0.01 to 3 mass % of a total mass of the composition.
